(19) United States
(12) Patent Application Publication
(10) Pub. No.: US 2007/0282776 A1
(43) Pub. Date: Dec. 6, 2007

(54) Method and system for service oriented collaboration

(75) Inventors: Rajesh Jaluka, Poughkeepsie, NY (US); Santhosh Babu Kumaran, Peekskill, NY (US)

Correspondence Address: CAHN & SAMUELS, LLP, 2000 P. STREET, NW, SUITE 200, WASHINGTON, DC, 20036, US

(73) Assignee: International Business Machines Corporation, Armonk, NY (US)

(21) Appl. No.: 11/446,192

(22) Filed: Jun. 5, 2006

(51) Int. Cl. G06N 5/00

(52) U.S. Cl. 706/45

(57) ABSTRACT

A system and method for one entity to have a collaboration model for guiding the interaction with any number of entities to standardize that interaction. The collaboration model in at least one embodiment includes at least one conversation model that provides the mapping of actions to system/application of other entities to facilitate the interaction. In at least one embodiment, when aspects of one collaboration model are used in other collaboration models, then the particular conversation model is associated with the new collaboration model.

### I. FIELD OF THE INVENTION

This invention relates to a method and system for one entity to use a collaboration model with any number of entities thus streamlining operations of the one entity.

### II. BACKGROUND OF THE INVENTION

When interactions are done with entities (e.g., providing services to a customer) the methods used for the interactions have to be manipulated to conform to the entity's systems/applications. An entity can be a customer, service provider, supplier, vendor, or another part of the entity from which the collaboration is originating. The collaboration is currently being accomplished using institutional knowledge or entity specific built interfaces to facilitate the collaboration required to be able to provide the desired/requested services. This approach leads to inefficiencies caused by the need to recode the software interface or remember the change if there is a change in the system of an entity along with the need for institutional knowledge to know how the interaction is to occur, for example, via web-service request, e-mail, orally or another form of communication. As such, there is not a uniform process to deal with different entities because the interactions are on an ad hoc basis from entity to entity. These interactions occur irrespective of the business context that is driving the messages flowing through the bus.

Applications need to emit multiple variants of the same message based on the behavior of the recipient applications. In a service environment, the same business process for a service provider will have different integration needs that vary based on different customer applications involved in performing the work. For example, a Service Request could result in a Service Request, Change, Work Order, or Task. The service request could result in a Create, Add to existing or Update. Based on the customer and target system, the originating application would have to emit different messages. There is lack of visibility of the state of the end-to-end process, because the states are hidden inside each application participating in the process. The applications have to explicitly broadcast, receive and display cross-application state information.

Applications have to implement complex logic that is manually defined to manage the state information of each interaction required by the business process.

The current approach to integration is that there is a dumb layer providing the integration services typically via an Enterprise Service Bus (ESB). The integration services do not know or care why different applications are talking to each other. In ESB, for a business process [or collaboration], one would have to configure all possible interactions with different systems. One would also have to specify which specific adapters are required to carry out the interfaction. Further, this has to be repeated for each business process.

ESB designs are stateless and not aware of the business context that is driving the messages flowing through the bus. ESB designs can include interactions that use existing Internet and intranet infrastructure between systems in an architecture where the integration is configured in a set way based upon the situation and the systems being used. This design approach includes no intelligence as part of the ESB.

### III. SUMMARY OF THE INVENTION

In at least one embodiment, the invention includes a method including retrieving a collaboration model for a particular situation, selecting the stateful component within the collaboration model, binding the conversation with an application of an entity using a conversation model associated with the stateful component when that stateful component requires a conversation, and repeating the selecting and. binding steps for each stateful component in the collaboration model. In at least one embodiment, binding the conversation includes retrieving the conversation model based on the entity with which the collaboration is occurring. In at least one embodiment, binding the conversation further includes communicating the parameters to a system of an entity which will perform an action required by the conversation model. In at least one embodiment, binding the conversation includes retrieving the conversation model based on the application being used by the entity with which the collaboration is occurring. In at least one embodiment, multiple entities are collaborated with for completion of the collaboration model. In at least one embodiment, the method further includes providing information about at least one of collaboration model utilization and collaboration model current usage. In at least one embodiment the provided information includes information about whether the conversation models are working. In at least one embodiment, the method further includes instantiating each stateful component of the collaboration method as each component is reached. In at least one embodiment, the stateful component manages the conversation models used to drive the collaboration model. In at least one embodiment, the method further includes adding a conversation model representing mapping for a new collaboration. In at least one embodiment, the method further includes modifying a conversation model for an entity due to a change in at least one of a system of the entity or an application of the entity.

In at least one embodiment, the invention includes a method including creating a collaboration model for a particular operational process that benefits from collaboration with at least one entity, and creating at least one conversation model that maps a component of the collaboration model for each component requiring interaction with the at least one entity to a system of that one entity.

In at least one embodiment, the invention includes a system including a first data storage containing a plurality of collaboration models, a second data storage containing a plurality of conversation models, at least one of which is useful in using at least one collaboration model stored in the first data storage, means for retrieving a collaboration model for a particular collaboration, means for progressing through components of the collaboration model, means for binding a conversation with an entity to perform an action based upon a conversation model for a component of the collaboration model, means for controlling the operation of the progressing means and the binding means.

In at least one embodiment, the invention includes a computer program product comprising a computer useable medium including a computer readable program, wherein the computer readable program when executed on a computer causes the computer to: select a collaboration model for a particular collaboration having at least one conversation model associated with the collaboration model, progress through the collaboration model, bind the conversation with an application of an entity using a conversation model associated with the stateful component when that stateful component requires a conversation to occur, and repeat the progression and binding operations for each stateful component in the collaboration model.

In at least one embodiment, the invention includes a system for providing and using a collaboration model, the system including a collaboration model database having a plurality of collaboration models representing end-to-end processes, a conversation mapping library having a plurality of conversation models with at least one conversation model being used in at least two collaboration models stored in the collaboration model database, an integration services agent in communication with the conversation mapping library and the collaboration model database.

Given the following enabling description of the drawings, the apparatus should become evident to a person of ordinary skill in the art.

### IV. BRIEF DESCRIPTION OF THE DRAWINGS

FIG. 1 illustrates an exemplary method according to at least one embodiment of the invention.

FIGS. 2A-2D depict an exemplary collaboration models and their use according to at least one embodiment of the invention.

FIG. 3 illustrates an exemplary collaboration model and its use according to at least one embodiment of the invention.

FIG. 4 depicts an exemplary method according to at least one embodiment of the invention.

FIG. 5 illustrates a block diagram of a system according to at least one exemplary embodiment of the invention.

### V. DETAILED DESCRIPTION OF THE DRAWINGS

The invention allows for use of a uniform process when collaborating with at least one entity. In one exemplary application of the invention, the invention allows for uniform provision of services from customer to customer with the integration services providing bidirectional mapping of services based upon a particular customer's applications/systems. The invention when in use allows for easy addition of a new customer by providing the conversation mapping to connect the customer's systems to the underlying business operations of the service provider.

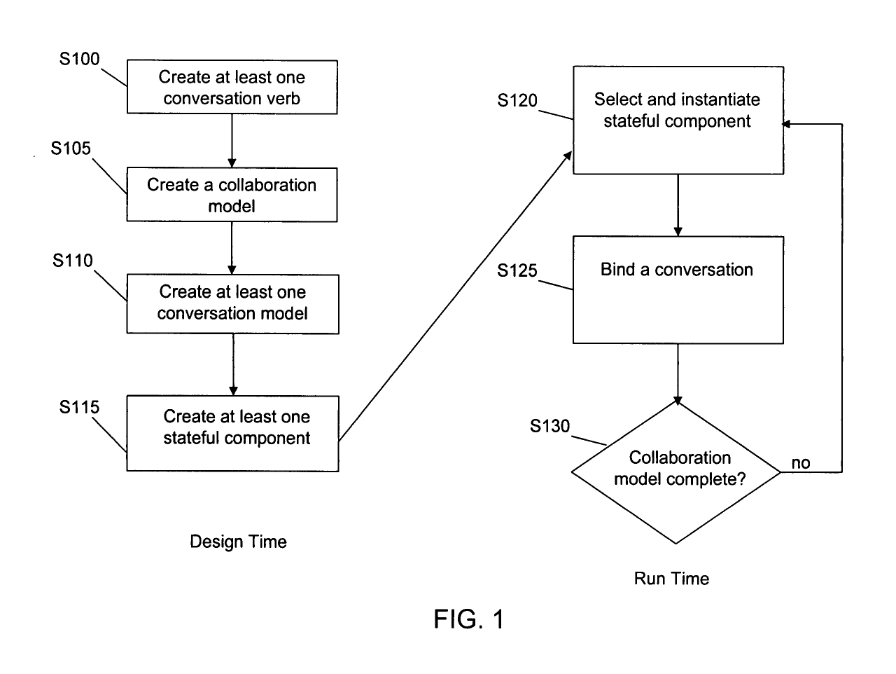

FIG. 1 illustrates an overview of an exemplary method for setting up a system for handling a collaboration with a customer, provider, supplier, or other entity using standard business operations for each class of entity. The other entity may include different operational units of the same company. Exemplary collaborations include providing services to a customer, requesting services or products from a provider or supplier that in turn may be further transferred or packaged for a customer. In general, a collaboration includes interactions with two different entities using the same model for both entities by having conversation model(s) to match the particular entity; however, the collaboration could be with just one entity.

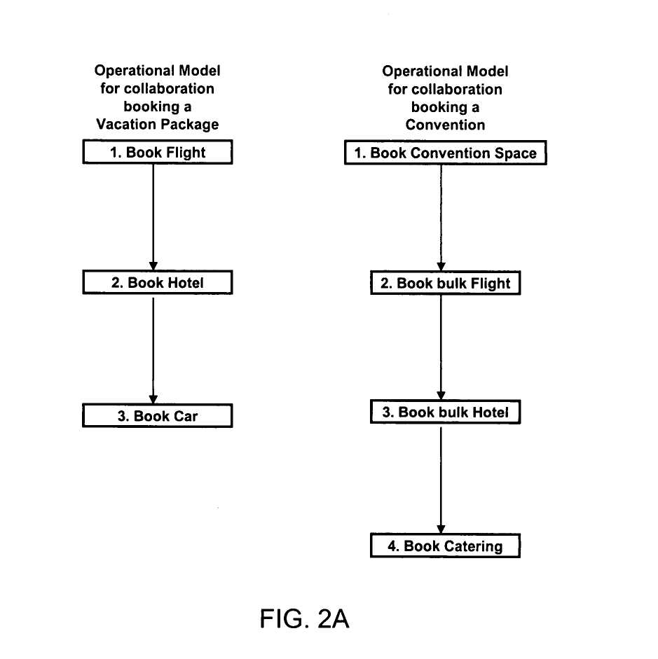

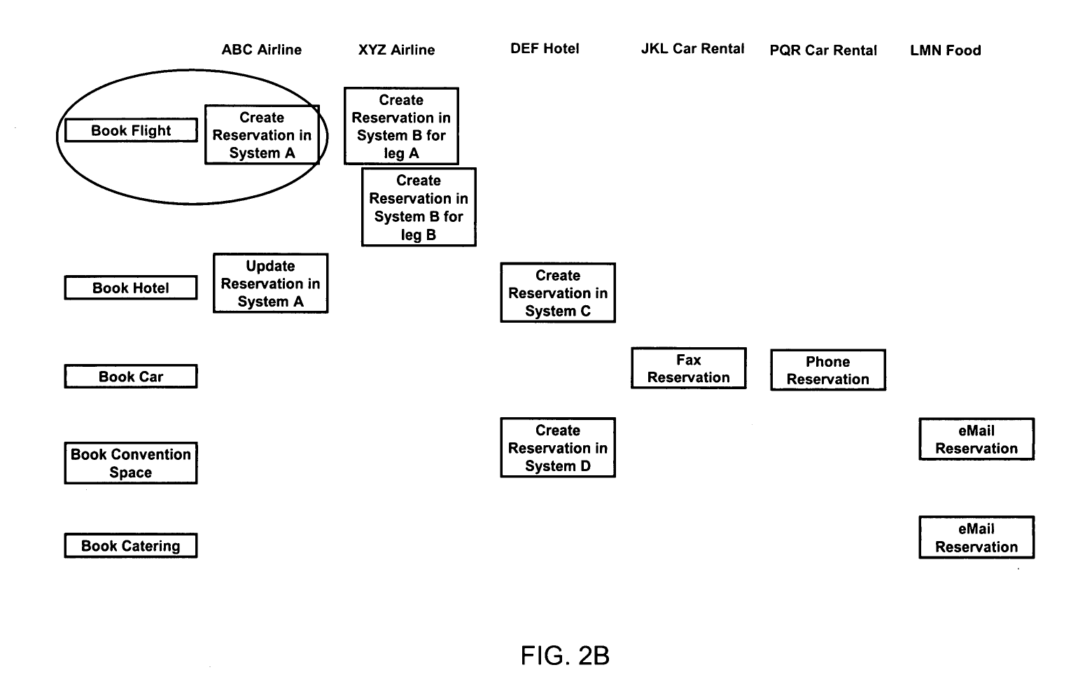

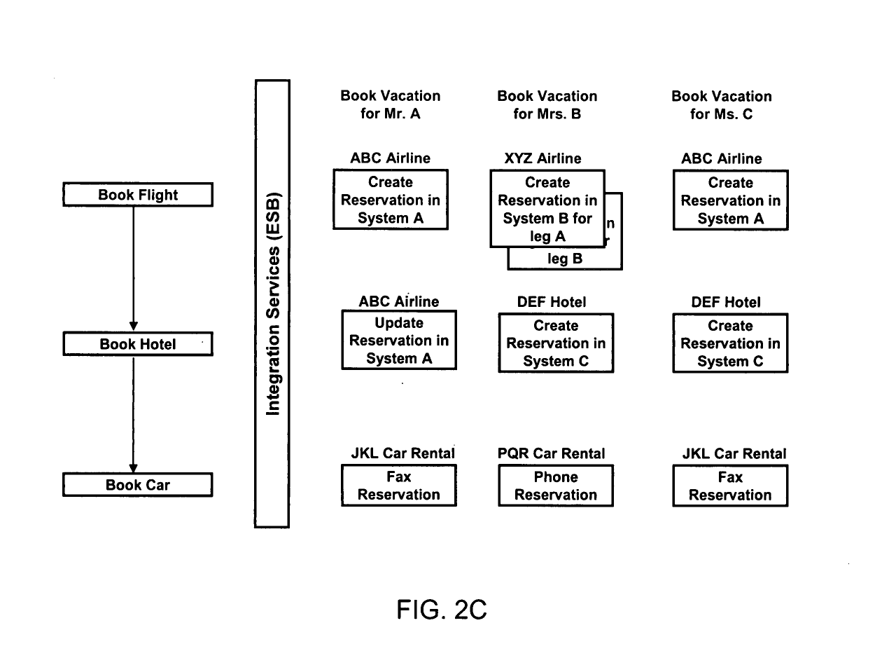

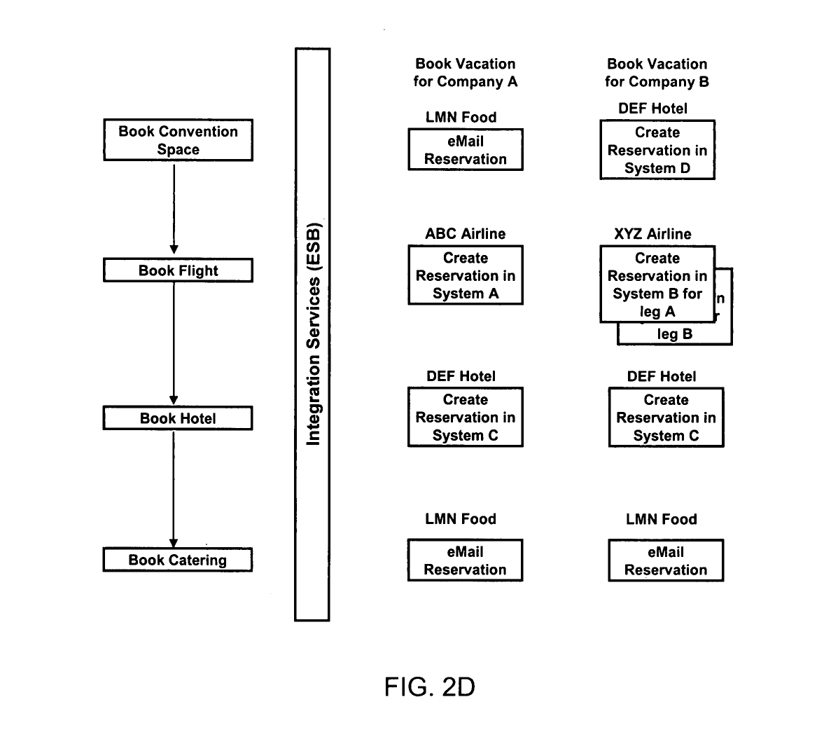

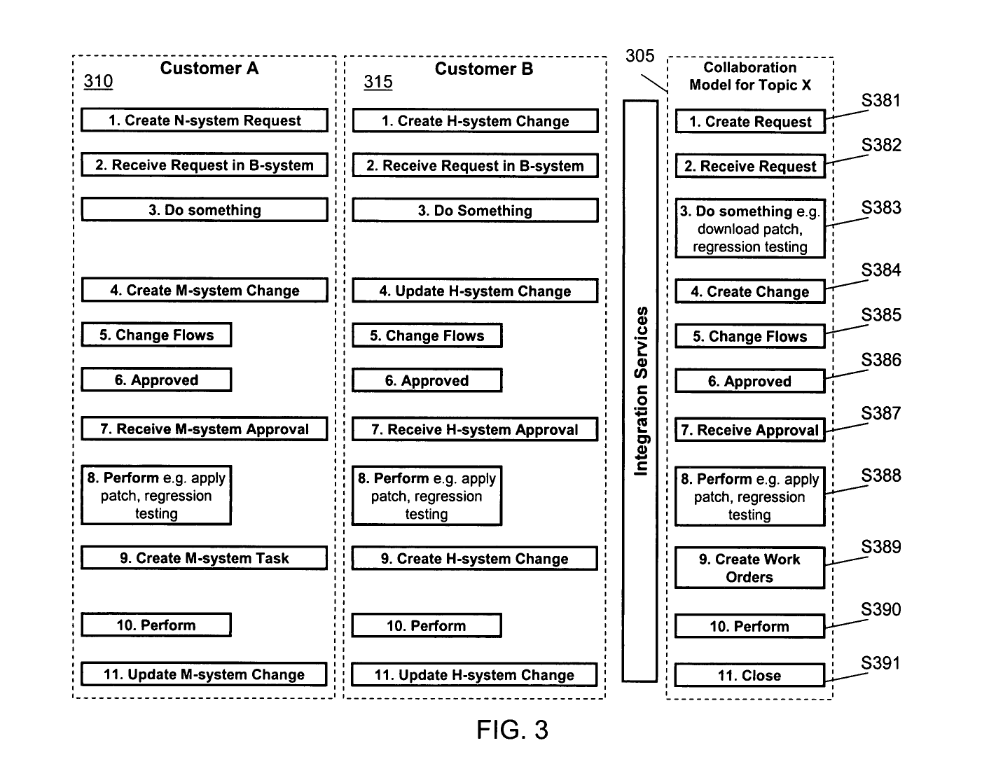

The illustrated method shown in FIG. 1 includes a design phase and an execution/use phase of the system. FIGS. 2A-3 will be used to further explain and provide examples of how the method illustrated in FIG. 1 would work. As one of ordinary skill in the art will appreciate based on this disclosure, the design phase, S105-S115, occurs once for initial setup (and possibly when a change occurs to an entity's system) while the runtime portion, S120 and S125, occurs repeatedly after setup to insure that collaborations such as providing services are able to occur with the entity based on the application and systems of the entity.

As illustrated in FIG. 1, the design phase for a collaboration model may include creating conversation verbs (or actions), S100, or alternatively retrieve existing conversation verbs from a library. The conversation verbs represent the action to be performed by the collaboration component. The conversation verbs provide a standardized nomenclature so that it is easier to determine whether a conversation in one collaboration model is the same as the conversation in another collaboration model. An example of a conversation verb is the “book a flight” in FIG. 2A in both the vacation package collaboration model and the convention collaboration model. As such the conversation verb is independent of the system or application to which it will provoke a conversation with as part of a collaboration. This will allow the developer of the collaboration model to create without worrying about what systems will be interacted with as that will be handled by the conversation model as discussed below. It is possible to omit this step and to create the conversation models in an independent manner.

The design phase as illustrated in FIG. 1 begins with creation of a collaboration model, S105, which is platform independent and thus allows for standardization of processes performed by an entity. The collaboration model is a method for doing something that includes a plurality of steps with examples including assembling multiple items into an overall package (FIGS. 2A-2D) or providing an IT service (FIG. 3). A pair of exemplary collaboration models are illustrated in FIG. 2A that are a collaboration model for interacting with at least one service provider. FIG. 2A illustrates the creation of a vacation package that includes the components of reserve a flight, S205a; book a hotel room, S210a; and book a rental car, S215. FIG. 2A also illustrates collaboration model for arranging a convention or other meeting that includes the components of book a convention space, S220; book a flight using a bulk code such as a corporate or meeting discount code, S205b; book a hotel using a bulk code, S210b; and book the catering service for the convention, S225. The flight and hotel booking collaboration components are the same except that under the convention collaboration model there is the additional parameter involved, which an example is an event or corporate code. The code could also be used with the vacation package collaboration model depending upon the particular situation.

FIG. 3 illustrates an exemplary collaboration model where the collaboration is with two customers for a particular Topic X relating to an information technology service. The interaction with Customer A includes interacting with N-system and M-system applications of Customer A and B-system being an internal application of the service provider. The interaction with Customer B includes interacting with H-system of Customer B and B-system being an internal application of the service provider. The collaboration model is illustrated as 305 with the particular actions for two exemplary customers using different systems and how the interaction will proceed with respect to them as 310 and 315.

The design phase illustrated in FIG. 1 includes creation of a conversation model(s) for the collaboration model to interact with different systems used by entities, Si 10. The conversation model represents the mapping required to perform a particular component in the collaboration model between at least two entities. The conversation model will include the action (or task) and the system (or application) of the entity to perform the action (or task). The conversation model in at least one embodiment includes the parameters to be passed and acted upon by the receiving entity or utilized in a latter collaboration component. A set (or group) of conversation models together provide the conversation mapping for a complete system. This information may, for example, be stored in a look-up table or database. In another exemplary embodiment, the conversation model may also include the way in which the communication is achieved, for example, one entity may interact through a web services call while another entity may interact, for example, via e-mail, fax, or orally.

FIG. 2B illustrates the different components used in the collaboration models illustrated in FIG. 2A. An exemplary conversation model is circled in FIG. 2B showing the action being performed with the system performing the action based on collaboration with the entity using the collaboration model. Each row in FIG. 2B is illustrative of different conversation models that might be used with the exemplary collaboration model, while the columns are for particular entities with no one entity in this example able to collaborate on each of the collaboration components.

For example, in FIG. 2B the entities for booking a flight include ABC Airline and XYZ Airline. The steps for booking a flight with ABC Airline include an action of “Create a Reservation in System A”. While to book a flight with XYZ Airline, a two step process is required that includes creating the outbound flight and creating the return flight both of which are sent to System B, XYZ Airline's reservation system. Both airlines would return to the collaboration model, flight reservations including price and itinerary in at least one exemplary conversation model, although the return of information could be omitted as illustrated in FIG. 2B.

To be able to book a hotel room as part of the package, in this example ABC Airline has a hotel booking feature that requires that the created flight reservation be updated to include a hotel room. A second hotel booking example is DEF Hotel, which interacts by having the booking occur by creating a reservation in System C, DEF Hotel's reservation system. Typically, each of the hotel reservations would produce at least a confirmation identifier and probably also price and other information about the stay that would be returned to the collaboration model as part of the conversation.

The book a car collaboration model component results in conversation models with JKL Car Rental and PQR Car Rental that instead of creating a reservation in a system, the booking occurs by faxing a reservation (JKL Car Rental) and telephoning in a reservation (PQR Car Rental). Each of the car rental entities would typically provide reservation information back via a communication channel from electronic message, a facsimile, or orally as part of the conversation model.

The book convention space is illustrated as having a pair of conversation models, with a reservation being created in System D for DEF Hotel and a reservation being e-mailed for LMN Food to book a convention space. LMN Food also has a similar conversation model for booking the catering for the convention. Each of these conversations is an example of a conversation model.

The example illustrated in FIG. 3 includes conversation models being present for steps S381, S382, S384, S387, S389, and S391; however, one of ordinary skill in the art will appreciate based on this disclosure that the other steps may also be subject to similar conversation models depending upon the particular applications being used by a customer and/or service provider. Step S381 is illustrative of how two different systems will view “Create Request” with Customer A having a request being created by N-system and Customer B having a change created by H-system. In step S382, the request from Customer A and the change from Customer B are both received as a request in the internal application of the system provider. In step S384, the create change step results in creating a change in M-system for Customer A and an update change in H-system for Customer B. Step S387 is illustrative of how a step of receive approval is implemented the same way by both Customers except for using their particular systems. In step S389, the create work orders is translated as creating a task in M-system for Customer A and creating a change in H-system for Customer B. The last step in the exemplary collaboration model is to close the service, which in step S391 becomes update a change in M-system for customer A and update a change in H-system for Customer B.

Step S115 in FIG. 1 illustrates creation of a stateful component for each instance of a step in the collaboration model. An exemplary stateful component according to the invention is an indicator of whether the step has been performed and the next component in the collaboration model to be used. The stateful component allows for easier monitoring of progress through the collaboration model.

The resulting product of the design phase is a collaboration model having at least one conversation model for how communication is to be handled between the collaboration model and an entity's system. The resulting collaboration model is useable with a plurality of entities based on the conversation model(s) created for the entity and/or the system used by the entity for accomplishing future communications. The collaboration model provides an end-to-end view of a business process independent of the participating target systems, and thus may be used across a variety of situations.

The runtime portion of FIG. 1, after retrieval of the collaboration model for the particular situation, begins with selection and instantiate stateful component, S120, to allow for selection of the appropriate collaboration model and tracking of the progress using the collaboration model. The next step, S125, is binding the conversation by selecting the correct conversation model and having the appropriate parameters or instructions be bound for the conversation. Binding the conversation includes ensuring that the parameters are sent to the correct system to complete the conversation model. These two steps are repeated, S130, as progress is made through the collaboration model with step S125 being used as needed as each component of a particular collaboration model as illustrated, for example, in FIG. 3 does not require that an interaction to occur between the operational model and an entity at, for example, S383 and S388. When the operational model is complete, the runtime phase is finished.

Referring to the example shown in FIG. 2C, when a consumer wants to purchase a vacation package using a travel site, the vacation package collaboration model is selected. FIG. 2C illustrates three exemplary combinations of service providers grouped together to provide the desired vacation package. FIG. 2C also illustrates the presence of an ESB, which in this example provides the Integration Services. The Integration Services utilizes the conversation mapping to determine which conversation model it should use to accomplish the collaboration model, which in the example shown in FIG. 2C includes selection of service providers that may be based on user input or determine according to service level agreements or business policies. Three travelers are illustrated in FIG. 2C, each of which has a vacation package using a different combination of service providers. Mr. A's vacation package includes a flight on ABC Airline, a hotel booked through ABC Airline, and a car rental from JKL Car Rental. The bookings with ABC Airline are accomplished using System A while the car rental is accomplished by a facsimile being sent to JKL Car Rental. As referenced above, as part of each collaboration component or as additional collaboration components, the different systems may return information regarding the reservation or booking that has been completed.

Mrs. B's vacation package includes a flight on XYZ Airline, a hotel booked directly with DEF Hotel, and a car rental from PQR Car Rental. Like with Mr. A, Mrs. B's flight and hotel were booked via a connection with the respective systems of XYZ Airline and DEF Hotel, while the car rental was accomplished via telephone with PQR Car Rental. The Integration Services knows based upon the provider and the relevant conversation model in this example of how to book the flight, the hotel, and the car rental for each of these entities.

Ms. C's vacation package illustrates the flexibility that is possible since the package includes a flight on ABC Airline, a stay with DEF Hotel, and a car rental from JKL Car Rental using the booking steps as provided by the relevant conversation model for each of these providers. The vacation packages for Mr. A and Ms. C both utilize the conversation models for book flight with ABC Airline and book car with JKL Car Rental.

FIG. 2D illustrates the management of conversations with ABC Airline, XYZ Airline, and DEF Hotel are the same as occurred in the vacation package collaboration model discussed above. This is an example of improved efficiency that is achieved by at least one embodiment according to the invention by having the Integration Services being able to pull the relevant conversation models from the existing conversation mapping to allow for varied collaboration that may not have been intended when the original conversation model was created. In particular, the book bulk flight and book bulk hotel in the convention collaboration model will require substantially the same conversation model that book flight and book hotel from the vacation package collaboration model with the addition possibly of a parameter for a code or other identifier to obtain particular pricing.

FIG. 3 illustrates an information technologies application of the invention as discussed above in connection with the conversation models. FIG. 3 is an example of how a request for an information technologies service may be implemented for two different customers while maintaining the same internal collaboration model for providing the information technologies service. Unlike current approaches, where the internal system would not be subject to mapping, the internal system also is mapped (see S382) which allows for the same flexibility in changing the internal system without impacting the collaboration model.

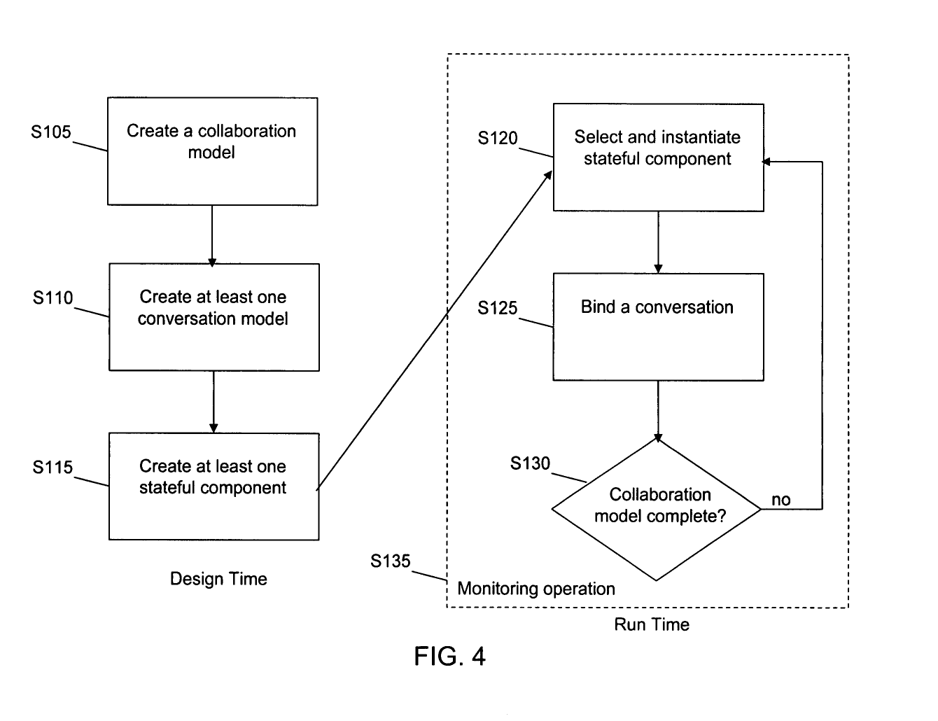

Another exemplary embodiment adds the tracking of collaboration status information and other transactional information, S135, as illustrated in FIG. 4. An exemplary implementation includes use of an administrative interface that shows the status of a transaction involving a collaboration model.

Another exemplary embodiment adds intelligence to the creation of a set of conversation model(s) for a particular collaboration model. As part of the setup of a conversation model, a check is performed to see if a particular conversation model is already in use. An example of this is if there is a second collaboration model for setting up a convention, illustrated in FIG. 2A, in addition to book a vacation package. The book a flight conversation model for ABC Airline and XYZ Airline could be reused in the convention collaboration model. This functionality allows for decoupling the activity to be performed as part of a collaboration from the conversation model needed to facilitate the collaboration, and thus reduces the number of the conversation models and potentially makes them as a group more likely to be generic conversation models useable in a variety of collaborations.

Another exemplary embodiment includes changing a conversation model when the other entity participating with a particular collaboration model changes it's system or has some other change including not participating in future collaborations. The change in the conversation model would include changing the action and/or system to allow for future collaborations to occur with that entity. Also, if a new entity wants future collaborations, then adding the relevant information for a conversation model(s) to fit the particular entity's system(s) to facilitate that future collaboration.

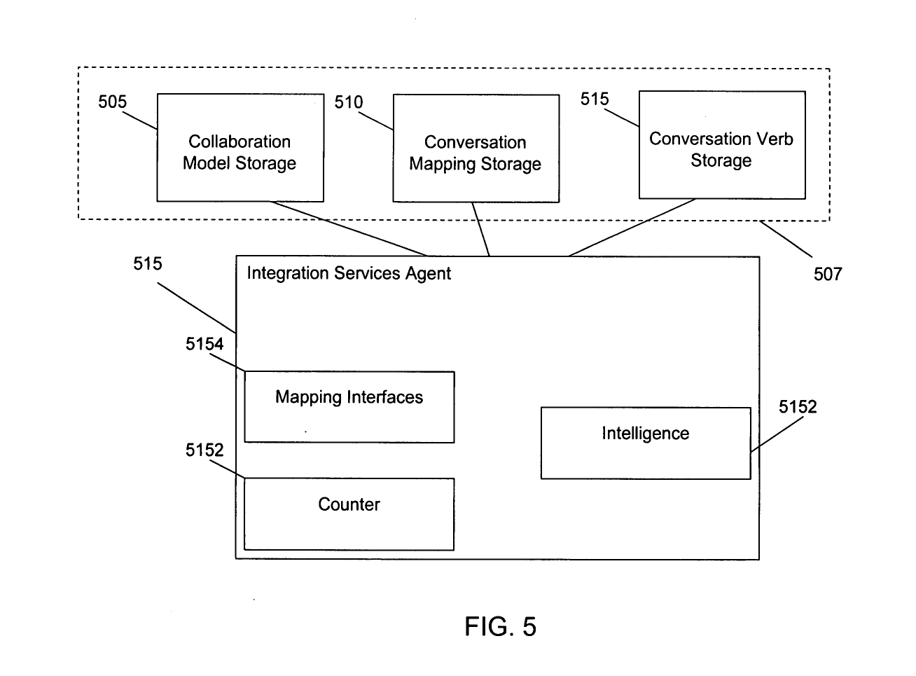

42 An exemplary system for the above-described method is illustrated in FIG. 5. The collaboration model is stored in any variety of storage arrangements (first data storage unit) 505 including a list(s), a table(s), a database(s), a library, etc. The conversation mapping likewise may be stored in a lookup table, a database, a library or other type of storage arrangement (a second data storage unit) 510 that allows for connection to be made between a collaboration model component and an activity to occur with another entity that includes the action to occur and the system to handle the action. The first and second data storage units 505, 510 may be combined together as one storage unit 507. The system also includes an integration services agent (or bus) 515 that tracks the performance of the collaboration model and retrieves the appropriate conversation model(s) to accomplish the collaboration model, i.e., binding the conversation with the relevant system of the entity participating in the collaboration. The integration services agent also tracks the stateful component within the collaboration model during runtime, for example, with a counter 5152. The integration services agent in at least one embodiment includes at least one mapping interface 5154 that allows the system to communicate in the necessary way as required by a particular conversation model.

The integration services agent also in at least one embodiment includes intelligence 5156 to recognize when a collaboration model component has previously been used before and to retrieve the needed conversation model(s) for that collaboration model component. This functionality allows for the different conversation models to be used in conjunction with a variety of collaboration models.

FIG. 5 also illustrates an alternative embodiment that adds a conversation verb storage unit 520 that includes a list(s), a table(s), a database(s), a library, etc. containing available conversation verbs.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium such as carrier signal. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-RNV) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method comprising:
retrieving a collaboration model for a particular situation,
selecting the stateful component within the collaboration model,
binding the conversation with an application of an entity using a conversation model associated with the stateful component when that stateful component requires a conversation, and
repeating the selecting and binding steps for each stateful component in the collaboration model.

2. The method according to claim 1, wherein binding the conversation includes retrieving the conversation model based on the entity with which the collaboration is occurring.

3. The method according to claim 2, wherein binding the conversation includes communicating the parameters to a system of an entity which will perform an action required by the conversation model.

4. The method according to claim 1, wherein binding the conversation includes retrieving the conversation model based on the application being used by the entity with which the collaboration is occurring.

5. The method according to claim 1, wherein multiple entities are collaborated with for completion of the collaboration model.

6. The method according to claim 1, further comprising:
providing information about at least one of collaboration model utilization and collaboration model current usage.

7. The method according to claim 6, wherein the information includes information about whether the conversation models are working.

8. The method according to claim 1, further comprising instantiating each stateful component of the collaboration method as each component is reached.

9. The method according to claim 8, wherein the stateful component manages the conversation models used to drive the collaboration model.

10. The method according to claim 1, further comprising:
adding a conversation model representing mapping for a new collaboration.

11. The method according to claim 1, further comprising:
modifying a conversation model for an entity due to a change in at least one of a system of the entity or an application of the entity.

12. A computer program product comprising a computer useable medium including a computer readable program, wherein the computer readable program when executed on a computer causes the computer to:
select a collaboration model for a particular collaboration having at least one conversation model associated with the collaboration model,
progress through the collaboration model,
bind the conversation with an application of an entity using a conversation model associated with the stateful component when that stateful component requires a conversation to occur, and
repeat the progression and binding operations for each stateful component in the collaboration model.

13. A computer program product according to claim 12, wherein the computer readable program further causes the computer to:
retrieve the conversation model from a storage unit.

14. A computer program product according to claim 12, wherein the computer readable program further causes the computer to:
transmit at least one parameter when the conversation is bound.

15. A computer program product according to claim 12, wherein the computer readable program further causes the computer to:
communicate with at least one entity based on the conversation model.

16. A computer program product according to claim 12, wherein the computer readable program further causes the computer to:
provide administrative information regarding operation of at least one collaboration model.

17. A system comprising:
a first data storage containing a plurality of collaboration models,
a second data storage containing a plurality of conversation models, at least one of which is useful in using at least one collaboration model stored in said first data storage,
means for retrieving a collaboration model for a particular collaboration,
means for progressing through components of the collaboration model,
means for binding a conversation with an entity to perform an action based upon a conversation model for a component of the collaboration model,
means for controlling the operation of the progressing means and the binding means.

18. The system according to claim 17, wherein the binding means includes means for communicating at least one parameter to the entity performing the action according to the conversation model.

19. The system according to claim 17, further comprising means for selecting the entity to collaborate with for at least one component of the collaboration model.

20. The system according to claim 17, further comprising means for providing administrative information regarding at least one collaboration model.

21. The system according to claim 17, further comprising means for updating at least one conversation model.

22. A method comprising:
creating a collaboration model for a particular operational process that benefits from collaboration with at least one entity, and
creating at least one conversation model that maps a component of the collaboration model for each component requiring interaction with the at least one entity to a system of that one entity.

23. The method according to claim 22, further comprising creating a stateful component for each collaboration component.

24. The method according to claim 22, wherein the collaboration model represents a complete end-to-end business collaboration.

25. The method according to claim 22, further comprising adding a new entity to work with the collaboration model by creating at least one conversation model providing mapping information into that entity's system to facilitate collaboration on at least one component of the collaboration model.

26. The method according to claim 22, wherein creating a conversation model includes locating an existing conversation model previously created for mapping a particular collaboration component.

27. The method according to claim 22, further comprising adding the created conversation models into a conversation mapping library.

28. The method according to claim 22, further comprising creating at least one conversation verb for use in the collaboration model.

29. A system for providing and using a collaboration model, said system comprising:
a collaboration model database having a plurality of collaboration models representing end-to-end processes,
a conversation mapping library having a plurality of conversation models with at least one conversation model being used in at least two collaboration models stored in said collaboration model database,
an integration services agent in communication with said conversation mapping library and said collaboration model database.

30. The system according to claim 29, wherein said integration services includes intelligence to determine when a conversation model is useable with a new collaboration model based on reuse of at least one component from a prior collaboration model.

31. The system according to claim 29, wherein said integration services agent includes a counter for tracking which component of the collaboration model is being used.

32. The system according to claim 29, wherein said integration services agent includes mapping interfaces capable of communicating with systems of other entities.

33. The system according to claim 29, wherein said collaboration model database and said conversation mapping library are resident in one storage unit.

34. The system according to claim 29, wherein said integration services agent includes
means for binding a conversation model that identify a system to communicate an action using at least one parameter for a component of the collaboration model,
means for locating conversation models to use with components of new collaboration models, and
means for processing each component of a collaboration model.

35. The system according to claim 29, further comprising a conversation verb library connected to said integration services agent.
